(19) United States
(12) Patent Application Publication
(10) Pub. No.: US 2015/0042795 A1
(43) Pub. Date: Feb. 12, 2015

(54) TRACKING SYSTEM FOR OBJECTS

(71) Applicant: RESHIMO LTD., JERUSALEM (IL)

(72) Inventors: Yosef Tsuria, Jerusalem (IL); Raphael Garbay, Jerusalem (IL)

(21) Appl. No.: 14/381,615

(22) PCT Filed: Feb. 28, 2013
(86) PCT No.: PCT/IL13/00024

§ 371 Date: Aug. 28, 2014

Related U.S. Application Data
(60) Provisional application No. 61/634,403, filed on Feb. 29, 2012.

(51) Int. Cl. G06K 9/00; G06K 19/07; G06K 7/00; H04N 5/225

(52) U.S. Cl. CPC G06K 9/00771; H04N 5/225; G06K 19/07; G06K 7/0008
USPC 348/143

(57) ABSTRACT

A system for tracking objects, in which each object has a wireless connected tag attached to it, and a motion detector. The tags transmit the identity of the object to a tag reader only when object motion is detected. The system includes an optical imaging system for surveilling the area, which optically detects and characterizes any motion in the area. The system control unit correlates the information from the tag reader and the optical motion sensor and thus associates each tag detected wirelessly to the optically detected motion, such that the identity of the optically detected motion is determined even without clear optical identification. This correlation may be performed by comparison of the time of detection of information from the tag reader with that of the optically detected motion. The system can be used in tracking objects such as toys whose identity cannot be determined by visual imaging.

### FIELD OF THE INVENTION

The present invention is directed at providing a system for the real time tracking of small objects such as toys, with high accuracy inside confined areas, such as a room, especially in situations where the object may not be clearly recognized by an optical tracking system.

### BACKGROUND

Real-time locating systems (RTLS) are types of local positioning systems that enable tracking and identifying the location of objects in real time. The simplest systems use inexpensive tags attached to the objects, and tag readers receive wireless signals from these tags to determine their locations. RTLS typically refers to systems that provide passive or active (automatic) collection of location information. Location information usually does not include speed, direction, or spatial orientation. These additional measurements could be part of a navigation, maneuvering or positioning system.

Numerous solutions have been proposed and used for RTLS, including the following:

(a) Active radio frequency identification (Active RFID)
(b) Active radio frequency identification-infrared hybrid (Active RFID-IR)

### (c) Infrared (IR)

(d) Optical locating
(e) Low-frequency signpost identification
(f) Semi-active radio frequency identification (semi-active RFID)
(g) Radio beacon

### (h) Ultrasound Identification (US-ID)

(i) Ultrasonic ranging (US-RTLS)

### (j) Ultra-wideband (UWB)

(k) Wide-over-narrow band

### (l) Wireless Local Area Network (WLAN, Wi-Fi)

### (m) Bluetooth

(n) Clustering in noisy ambience
(o) Bivalent systems

In general the solutions can be divided into two main groups:
(i) Those in which objects are tracked by means of identification tags attached thereto
(ii) Those in which the objects being tracked do not have any tag attached to them, but are tracked by cameras or another remote wire-less tracking system. The main issue with solutions of type (i) above is the cost of tags and the readers. In order to achieve good in-room positioning, an RF based solution is not good enough because of the presence of back scattering, which can make positive identity of the position of the tag difficult. UWB and Ultrasound can be successfully implemented, but are comparatively costly technologies and require an on-board battery. Also, in order to achieve exact positioning, there need to be two or three readers to cover the entire area, which adds cost and complexity, and which may have a potentially unfriendly installation procedure because of the need to perform a preliminary calibration process. Another issue is that even if the system is able to provide the position of the tracked object, it may not be able to extract its orientation, for instance, whether it is standing vertically or laying horizontally; in which direction it is facing; and the like.

The type (ii) camera based systems, on the other hand, suffer from the known difficulties in the field of object recognition, which may be difficult or costly problems to solve. In many cases, such camera based systems cannot identify small objects, especially in the case of toys, such as if those objects are partially covered by the hand that is holding them, or if they are objects such as cards with the informative face away from the camera. Furthermore, two objects can look exactly the same, such as two similar dolls, or two similar cars in the toy example, and a camera system may then be unable to differentiate between them in order to provide the correct information.

A number of prior art publications address the problem of attempting to define the position of objects in space in real time.

In US2006/0273909 to M. Heiman et al, for “RFID-based Toy and System”, there is described a system for enabling toys to interact with a computerized entity by means of RFID tags installed within the toys.

In US 2010/0026809 to G. Curry, for “Camera-based Tracking and Position Determination for Sporting Events”, there is described a system for providing improved information on the position of balls or players in a game or sporting event, using position detectors on the balls or players in order guide or select, inter alia, a video camera, or camera shot type, or camera angle to provide a multimedia presentation of the event to a viewer. However, the cameras do not appear to take any part in the determination of the position of the balls or the players, which are uniquely defined by the sensors thereupon. The cameras merely function to provide better information to the viewer or the referee regarding the field of view containing the ball or players at any instant.

In US 2007/0182578 to J. R. Smith, for “RFID Tag with Accelerometer”, there is described a system in which one or more accelerometers may be coupled to an RFID tag so that the response of the tag indicates the acceleration of the object to which the tag is attached. This system thus enables position detection to be made, relying solely on RFID transmitted information.

In US 2011/0193958, to E. L. Martin et al., for “System and Method for determining Radio Frequency identification (RFID) System Performance”, there is described a system for determining RFID performance, which includes: (i) an RFID identity and position indicating system, the position being determined by using return signal strength indicator (RSSI) technology on the signals received by the RFID reader antenna and (ii) a video motion capture system comprising at least one camera and its processing system for providing recognition and position data of the same object whose identity and position was determined by the RFID system. Correlation of the outputs of the two systems enables the performance of the RFID system to be determined vis-a-vis the video system output.

In the article entitled “A Scalable Approach to Activity Recognition based on Object Use” by J. Wu et al, published in IEEE 11th International Conference on Computer Vision, ICCV 2007, pages 1-8, there is described a system in which RFID information providing the position of various items being tracked is supported by a prior knowledge of specific activities and by recordings from a video camera. The motivation is not to accurately locate the items, but to identify the specific activity from a set of activities.

There therefore exists a need for a simple system for providing real time tracking of small objects, such as toys, with high accuracy, preferably to within 1 cm, inside a confined area such as a room, especially in situations where the object may not be clearly visible to an optical tracking system. There is also a need to accurately identify and discriminate between two objects touching or very close to each other, this being a task that is not solved cost-effectively by the existing technologies used in the field.

The disclosures of each of the publications mentioned in this section and in other sections of the specification, are hereby incorporated by reference, each in its entirety.

### SUMMARY

The present disclosure describes new exemplary systems for accurately tracking small items inside a space such as a room. The system has particular applicability to the field of toys and games, enabling the acquisition of the identity and the real time position of an object being moved, even in situations where the hand of the person handling the toy or game part obscures major details of the toy or game part being moved, or where the items being played with are essentially identical visually, either because they are identical physically, or because they are different but the difference cannot be discerned from all viewpoints.

To attain this, the system advantageously comprises two components parts—(i) a wireless identity and motion detection system, comprising a sensing unit(s) or tag(s) attached to the object(s) to be tracked, and providing its identity, and (ii) a motion tracking camera system, viewing the entire area in which the object(s) is situated and receiving therefrom visual information about the motion, position and velocity of the object(s) being tracked. These two aspects—the identity and motion information received electronically from the object-mounted tag and its reader, and the position and motion information received visually from the camera system, about the object being tracked, are combined by the control unit. The combination of these two component information parts provides the present system with unique capabilities beyond what is shown in the prior art.

The sensing unit may be an RFID chip, optionally a passive chip powered by the RF radiation emitted by the RFID reader. At least one accelerometer is attached to the ID tag, optionally a MEMS based accelerometer, in order to provide the motion information required relating to the object being tracked. Alternatively, a simple motion sensor could be adequate for many cases, especially in the low cost home-toy applications. Such motion sensors could be based on such physical properties as optical sensing (such as in a computer mouse), mechanical sensors, RF field sensors or magnetic sensors.

An alternative, and currently more convenient method of communicating with the sensing tag is by means of a WiFi link, communicating with the control unit by means of an ad hoc WiFi protocol. Since many mobile phones and smart television sets are equipped with WiFi capability, they can communicate directly with the sensing tag, either acting as the control unit itself, or maintaining contact between the sensing tag on the object to be tracked and the separate the control unit. Furthermore, smart phones and increasingly, even smart TV's, generally include camera facilities, such that the phone or TV can act not only as the control unit for communicating with the tag on the object to be tracked, but also as the motion tracking camera, providing the second arm of input data for operation of the system of the present disclosure. This provides a real cost and convenience advantage over the basic configuration above, by combining both separate functions in a single module.

According to one exemplary method of operation, the Wi-Fi or RFID chip answers the Wi-Fi or RFID Reader only when it is in motion, as determined by the accelerometer or motion sensor.

The control unit is most conveniently installed in a console for the toy or game, and may include the following subsystems:

(i) An RFID or Wi-Fi reader subsystem
(ii) A Motion Tracking Camera subsystem, preferably with an optional depth calculation capability, and
(iii) A processor for controlling the integration of all of the incoming information.

In typical use, when a person moves the object with the sensing unit associated therewith, the Reader is then able to read the data transmitted by the object mounted sensing unit. This data generally comprises the tag's ID in order to characterize which object is being tracked, and optionally, also additional information from the accelerometer or motion sensor regarding the motion of the object. In parallel, the Motion Tracking Camera subsystem analyzes the scene and identifies any moving objects by simple means, such as frame comparison.

When the controller processor finds a temporal correlation between the information from both the sensing unit and the camera subsystem, it registers that a tag-based object is in motion, and it continues to track it by means of the camera subsystem.

One advantage of this scheme over conventional camera tracking using object recognition is that the current method is effective for tracking multiple objects, even if the objects' paths cross or coincide, such as would occur in a collision between two toy cars. When reliance is made on object recognition for tracking, such a situation is difficult to resolve because the objects may mutually screen each other. On the other hand, using the system of the present disclosure, since the identity of the objects in such a situation continue to be clearly received, and the motion tracking camera or cameras are used only in order to track the paths of the objects being followed, the collusion of two paths does not detract from the efficiency or ability of the system.

In the simplest configuration of the system, the information from the motion sensor or accelerometer may comprise no more than the fact that an object has started moving, in order to enable its tag to provide data about the identity of the object moving. More complex configurations, besides enabling the reading of the identity of the moving object, could include spatial and velocity information obtained from the accelerometer, since double integration of the accelerometer output with time provides a profile of linear spatial position. Two orthogonally positioned accelerometers could be used to provide position data in two dimensions. Such information could then be used to support the positional data obtained from the Motion Tracking Camera subsystem.

It is to be understood that although the system has been described incorporating the widely used Wi-Fi or RFID chips to provide identity information, it is not intended to be limited thereto, but could be implemented with any suitable device for conveying the identity of the object to which it is attached or associated, such as a Bluetooth or NFC tag, or even tags to be devised in the future. The important feature here is that of a tag of any sort, capable of providing ID information when enabled to do so by the motion of the object associated with the tag.

There is thus provided in accordance with an exemplary implementation of the devices described in this disclosure, a system for tracking at least one object in a surveilled area, the system comprising:

(i) an electronic tag and a motion detector associated with the at least one object, the tag being enabled to transmit the identity of the object when the motion detector provides an output indicating motion of the object,
(ii) a tag reader adapted to detect any identity transmission from a tag in its vicinity,
(iii) an optical detection system for surveilling the area, the system adapted to optically detect motion in the area, and
(iv) a control unit adapted to temporally correlate information from the tag reader and the optical detection system and to ascribe the identity of a tag detected to an object whose motion is optically detected.

In such a system, the temporal correlation may be performed by means of comparison of the time of detection of information from the tag reader and from the optical detection system. In order to achieve this, the control unit may be adapted to instruct the optical detection system to track an object when the motion is optically detected and the identity transmission is received within a predetermined time interval. In this case, the controller may be adapted to ascribe the identity of the object tracked by the optical detection system according to the identity determined by the tag reader from the identity transmission.

Any of the above described systems may be operative even when the visual features of the at least one object are not discernible to the optical detection system. Alternatively, the systems may be operative even when the at least one object is a plurality of objects having the same visual appearance, but whose tags provide unique identity information. In any event, the ascribed identity of the tag detected by the optically detected motion should enable tracking of discrete objects which cannot be distinguished visually by the optical detection system.

Furthermore, any of the above-described systems may further comprise a display device receiving input data from the control unit relating to the at least one object tracked by the system. This input data may be such as to show on the display at least one image showing the location of the at least one object tracked by the system, and this at least one image showing the location of the at least one object tracked by the system may follow the motion of the at least one object in the surveilled area. In alternative implementations, the input data may be such as to show on the display video information relating to the at least one object tracked by the system.

Additionally, at least one of the tag reader, optical detection system, control unit and display may advantageously be incorporated into a smart electronic device, which could be any one of a smart phone, a smart television set or a portable computer.

In yet other implementations, the system may further include a server having connectivity with other components of the system, such that information regarding tracking events can be stored on the server and retrieved from the server.

In other exemplary implementations, the motion detector may comprise at least one accelerometer, such that it can transmit electronic information relating to the motion of the at least one object. In such a case, a motion analyzing module may also be provided, such that the electronic information relating to the motion of the at least one object, can be correlated with the information from the optical detection system.

In any of the above described systems, the electronic tag may be either a Wi-Fi tag or an RFID tag.

Still other exemplary implementations involve a method for tracking at least one object in a surveilled area, the method comprising:

(i) providing the at least one object with an electronic tag and a motion detector, the tag transmitting the identity of the object when the motion detector provides an output indicating motion of the object,
(ii) detecting any identity transmission received from a tag in the area,
(iii) optically detecting motion in the area with an optical detection system, and
(iv) temporally correlating the tag associated with any identity transmission received, with optically detected motion, and
(v) ascribing the optically detected motion with the identity of the tag whose identity transmission was detected.

In such a method, the correlating may be performed by comparing the time of detection of the identity transmission with the time of optically detecting the motion. In such a case, the tracking of the at least one object may be performed when the optically detected motion and the identity transmission are received within a predetermined time interval.

Any of these methods may be operative even if the visual features of the at least one object are not discernible to the optical detection system. Additionally, the methods may be performed even when the at least one object is a plurality of objects having the same visual appearance, but whose tags provide unique identity information. In any case, the ascribed identity of the tag detected to the optically detected motion should enable tracking of discrete objects which cannot be distinguished visually by the optical detection system.

Furthermore, any of the above-described methods may further comprise the step of presenting on a display, information relating to the at least one object tracked. This information may comprise location information about the at least one object, and this location information may track the motion of the at least one object in the surveilled area. In alternative implementations, the information may comprise video information relating to the at least one object tracked by the system.

Additionally, at least one of the steps of detecting an identity transmission, optically detecting motion, temporally correlating, ascribing and presenting on a display, may be performed on a smart electronic device, which could be any one of a smart phone, a smart television set or a portable computer.

Further exemplary methods may also comprise the additional step of connecting with a server, such that information regarding tracking events can be stored on the server and retrieved from the server.

In other exemplary implementations, the motion detector may comprise at least one accelerometer, such that the motion detector can transmit electronic information relating to the motion of the at least one object. In such a case, the method may further comprise correlating the electronic information relating to the motion of the at least one object, with the optically detected motion.

Any one of the above-described methods may be implemented with the electronic tag being either a Wi-Fi tag or an RFID tag.

Finally, according to yet another exemplary implementation of the devices described in this disclosure, there is provided a system for tracking at least one object in a surveilled area, the system comprising:

(i) an electronic tag and a light sensor associated with the at least one object, the light sensor being adapted to provide an output signal when a change in the level of light caused by motion of the object is detected, and the tag being enabled to transmit the identity of the object only when the light sensor provides such an output signal,
(ii) a tag reader adapted to detect any identity transmission from a tag in its vicinity,
(iii) an optical motion sensor system for surveilling the area, the system adapted to optically detect and characterize any motion in the area, and
(iv) a control unit operative to correlate the information from the tag reader and the optical motion sensor and to ascribe the identity of the tag detected to the optically detected motion.

### BRIEF DESCRIPTION OF THE DRAWINGS

The present invention will be understood and appreciated more fully from the following detailed description, taken in conjunction with the drawings in which:

FIG. 1 shows a schematic representation of an exemplary identification and tracking system of the type described in this disclosure;

FIG. 2 illustrates schematically a flow chart showing how the detection and identification procedure of the system shown in FIG. 1 may operate;

FIG. 3 shows a block diagram illustrating the component parts of the systems of this disclosure, in a generic form;

FIG. 4 shows a scenario of the present system active in a game involving multiple players and identical toys;

FIG. 5 shows a scenario in which recognition is made immediately of a child's selected object from among multiple objects; and

FIG. 6 illustrates yet another scenario, this time involving a card game.

### DETAILED DESCRIPTION

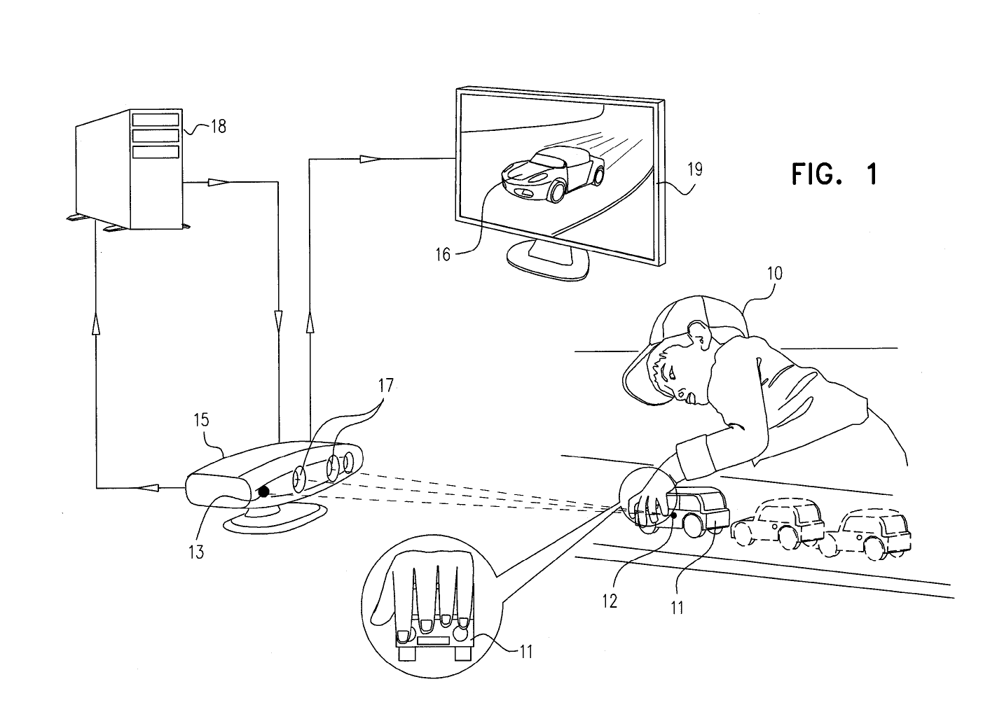

Reference is now made to FIG. 1, which illustrates schematically an exemplary identification and tracking system of the type described in this disclosure. The user, in this example a child 10, is moving the object to be tracked, in this case a toy car 11. The motion is indicated in the drawing by the sequential outlines of the car 11 in the direction of the motion. The car is fitted with a sensing unit 12, as indicated by the black spot on the car. Such a sensing unit should incorporate a chip or tag, such as an RFID or Wi-Fi chip, to uniquely identify the car from other cars in the vicinity, and an accelerometer or motion sensor (not shown in FIG. 1) to provide information regarding the movement of the car. The chip can be passive or active. The chip could also have a non-volatile memory (NVM) and a CPU, to enable it to perform, for instance, cryptographic functions. The chip is functionally coupled to the accelerometer or motion sensor, and may optionally be designed to remain silent until the accelerometer or motion sensor outputs a signal indicating that the object has begun motion. Once motion is detected, the chip communicates its identity to the chip reader 13, which may be located in a console 15. This motion-dependent communication to the reader 13 can be either an initiative of the tag, transmitting its identity as soon as the motion sensor provides a positive signal, or alternatively, it can be a transmission in response to the repeated interrogation by the tag reader, which can only read the tag identity when accompanied by the motion sensor enablement.

Additionally, the object may incorporate a generator that provides power to the chip from the motion of the device. In such a situation, there would be no need for a separate accelerometer input to provide the information that the car is moving, since without power provided by the motion, the tag 12 in this implementation cannot transmit its identity information.

The tag may be mounted on the surface of the object, and may also include a light sensor that sends alerts when there is a change in the amount of light it measures, implying that the object has been removed from the floor, or has otherwise changed its location or spatial association significantly. For example, when the child removes a tagged hat from a doll's head, or when the child removes a car from the floor.

The interface and control functions of the tracking system may be performed in the Console 15, whose functions include tracking the movement, velocity and relative position of the car being tracked. The Console may advantageously incorporate the following Subsystems:

### (i) a Tag Reader Subsystem.

This is a system that communicates with any tag located within its region of detection, typically a room. The purpose of this subsystem is to recognize the identity of the moving objects. However it is not necessary that any directional or positional information need be gleaned from the RFID being detected.
(ii) a Motion Tracking Camera Subsystem, with Optional Range Calculation Capabilities.
Video tracking is the process of locating a moving object (or multiple objects) over time using a camera. Conventional video tracking is based on the association of target objects in consecutive video frames. The association can be especially difficult when the objects are moving fast relative to the frame rate. Another situation that increases the complexity of the problem is when the tracked object changes orientation over time. Video tracking can be a time consuming process due to the amount of data that is contained in video. Adding further to the complexity is the possible need to use object recognition techniques for tracking.

However, the Motion Tracking Camera subsystem of the present system overcomes a major part of these potential problems of conventional Video Tracking, since the present system obviates the need for rigorous target recognition. The object recognition is performed by the tag interrogation, and the Motion Tracking Camera subsystem merely has to lock onto the moving object and follow its motion, without the additional burden of positive identification. Typical camera lenses 17 of the Motion Tracking Camera subsystem are shown in the forward section of the console 15. The Motion Tracking Camera should also be able to receive an instruction to track the object when the motion sensor provides an indication that the object is no longer in contact with the floor, but has, for instance, been lifted. This can be achieved in a number of ways, such as for instance, an optical sensor whose output is programmed to initiate a response when it detects a significant change in the amount of light that it measures.

Motion Tracking Camera systems are becoming available today in the living rooms to monitor the human body. However, unlike currently available systems that focus on human body movements, the subsystem used in this application focuses simply on objects that are moving. This is achieved by focusing initially only on the hands and on objects that they grasp. Once the objects are recognized the camera can continue to monitor them.

The advantage of the present system over prior art systems is that there is no need for the motion tracking camera subsystem to recognize the object. Recognition is achieved by the RF subsystem—the motion tracking camera subsystem just needs to identify an object in motion, assumed to be a car, and to follow its path. Thus, for instance, in the system shown in operation in FIG. 1, the camera system may not even be able to decipher the shape of the car 12, because the hand of the child may be shielding the car itself from the camera field of view, as shown in the inset. But once the motion tracking camera subsystem has locked onto the moving hand/car combination, it will continue to follow it even though the shape of the moving object may change with time as the child's hand changes grip or direction. By this means, the tracking system architecture can be made substantially simpler, since object recognition and its motion are handled by two completely independent subsystems. Furthermore, the object recognition itself is of a much simplified form than that of prior art object recognition systems, which rely on full visual recognition of the tracked object.

(iii) a Processor Running a Monitoring Application
The processor 18 receives data from both subsystems and, using a monitoring application running on it, correlates them in order to provide tracking output data. It constantly, for instance, at 25 Hertz, reads the tag information and the Motion Sensor information, and in parallel analyses the content from the Cameras and looks for moving objects in the frames. If data is received from the cameras indicating that movement has been detected, but no data has been read from a tag to indicate motion of a car in the camera's field of view, the processor is programmed to ignore the detected movement. Only if movement is detected by the camera subsystem, simultaneously with reception of an RF signal, does the application instruct the camera system to continue tracking the detected motion, while attributing that motion to motion of the car designated by the specific tag information received. Although the processor unit is shown in FIG. 1 as being a stand-alone computer system, it is to be understood that the control of the system can be implemented by means of a microprocessor installed in a micro controller, for instance, installed within the console itself, or even within a smart device such as a smart phone, or a smart TV or a laptop computer, as will be described hereinbelow.

If motion is detected from more than one object, the CPU correlates the information from both motion sources. If the Motion Sensor provides specific data (i.e. direction, speed) such correlation is straightforward, but even if the Motion Sensor doesn't provide any information other than the presence of motion, since the tag provides ID data only when it moves, it is comparatively simple to perform time-base correlation and thus to link the correct moving object with its correct ID.

Finally, the CPU can provide, for instance, a signal enabling the motion of the car to be displayed as an avatar 16 on the screen 19, with the image processing aspects of the camera motion sensor subsystem having removed the hand of the child from the image to provide a lifelike representation of the moving toy car 11. An audio component of the display

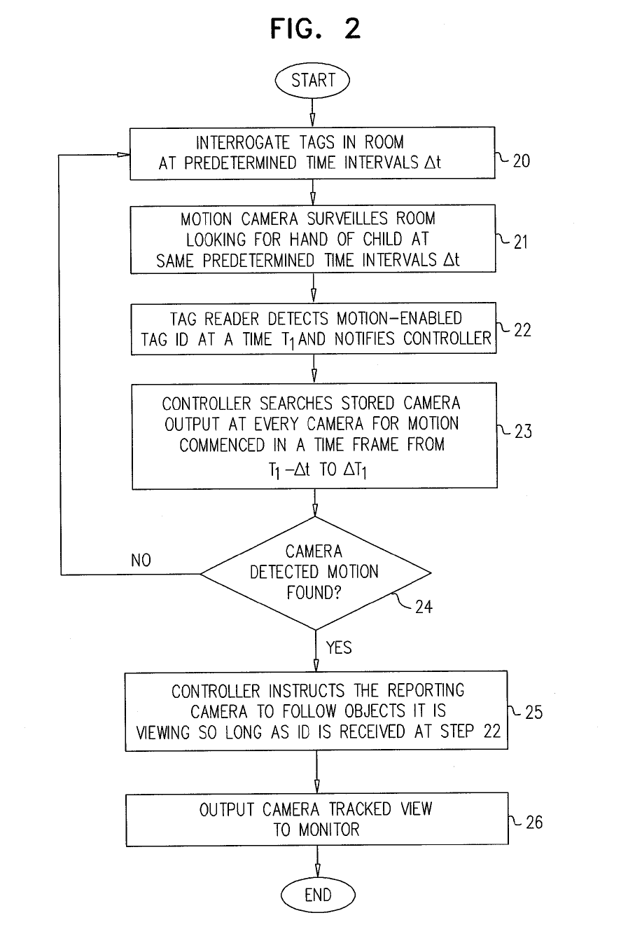

Reference is now made to FIG. 2, which illustrates schematically a flow chart showing how the complete detection and identification procedure operates, for the example of the system shown in FIG. 1 tracking the position of cars moved by a child's hand. At the start of the procedure, in step 20, the reader is interrogating all the tags in the room at predetermined time intervals of Δt, looking for a tag response which will indicate that the object associated with that tag is in motion. At the same time, in step 21, the motion camera is surveilling the room looking for any image or images of a child's hand. In step 22, at a time T1, the tag reader has detected a motion-enabled tag and its identity, and sends this information to the controller. In step 23, on receipt of such data, the controller searches the stored camera output (of every camera surveilling the room, if there is more than one) for hand motion commenced within the time frame Δt previous to the point of time T1, i.e. within the time period since the previous reader interrogation. In step 24, if no such motion is found, it is assumed that the motion signal received by the tag reader is not relevant, and the system continues to interrogate the tags in the room according to step 20. If, on the other hand, camera detected motion is found, then in step 25, the controller determines the position of the hand detected by the camera, and associates that position with the identity of the tag whose signal triggered the determination that a significant motion of the object(s) being tracked had been detected. The controller outputs the combined position/identity data to the system memory, and may output the camera tracked view of the object to a monitor, as in step 26. This last step thus represents that the object of the system has been fulfilled.

The flowchart above has been presented for the case in which the tag is a passively communicative tag, which responds to an interrogation signal from the reader. However a similar flowchart can also be devised for the active case in which the tag transmits its identity as soon as its motion is sensed, and the tag reader immediately picks up this transmitted identity signal. In such a case, the significance of the timing scale presented in the flowchart is different, in that the controller should then search for camera detected motion concurrently with reception of information from the tag about commenced motion, but otherwise the features of the method are similar.

A number of additional features can be incorporated into the system, such as an auto sleep mode for the Console if no motion is monitored for a predetermined time, such as 10 minutes. This is particularly important for a system to be used by children, since children are likely to simply collect their toys and walk away after the games are over, without remembering to turn the system off. The sleep mode can be adapted to arouse the system for instance, when a motion is detected, or at predetermined times following entry into the sleep mode, by means of a signal transmitted to the tags from the console. Such configurations may require that the tags be capable of two-way transmission rather than just act as one way beacons. As in most games situations, the CPU is programmed to save the last situation in the Server.

Additionally, the console can be divided into two physical modules—with the tag Reader in one unit and the Camera motion tracking subsystem in another. Both subsystems should be able to communicate over any communication network (eg Bluetooth, WiFi, etc.). The advantage of such an arrangement is that it is possible to locate the tag reader closer to the objects, to increase the range or signal-to-noise of the tag reader.

Finally, the combination of RFID reader and camera enable a much more cost effective solution to be provided for tracking functions and for relative positioning of two objects such as, when they do collide. In such a situation, a camera alone is not useful, since it doesn't provide unambiguous Object Recognition.

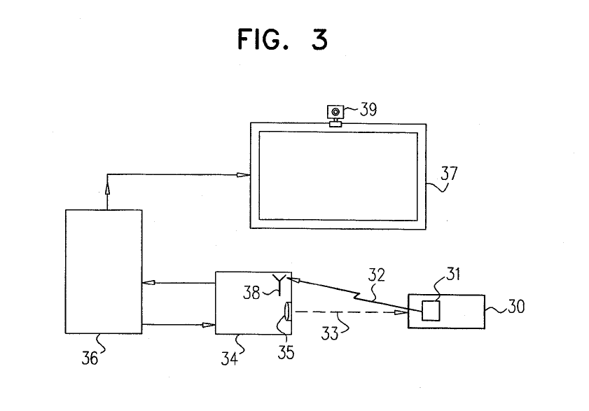

In order to simplify a description of the implementation of the systems of this application, in FIGS. 1 and 2 above, a specific system has been described based on discrete functional components. Reference is now made to FIG. 3, which illustrates schematically the basic component functions of the systems of the present disclosure, in a block diagram generic form. Thus in FIG. 3, the tracked object 30 is shown with its RF tag transmitting wirelessly 32 to the antenna 38 of the game console 34. The optical system of the system surveys the field of view 33 through its lens system 35. The data output from the game console is transferred to a processor or server 36 which executes the routines necessary for operating the system, including the generation of images of the object being tracked and its movement, for display on the screen 37 together with its sound component, and which can maintain libraries of the identity of the items tracked and their history.

However, some of the individual components shown in FIG. 3 can be combined into smart devices, such that the entire system becomes substantially simpler and its component modules less dedicated. Thus, for instance, while the display screen is shown in FIG. 1 as a computer monitor screen 19, it could equally well be implemented by a smart TV, which could include its own computing abilities, with connectivity to other smart components, and its own camera. In such a case, several of the functions of the components shown in FIG. 3, including the game console 34, and its optical system 35, and even part of the function of the processer 36 could be fulfilled by the single smart TV with its camera 39, thereby rendering the system substantially simpler and cost-effective, and more accessible without the need for dedicated equipment, beyond the tag equipped objects to be tracked, and the software for operating the entire system. Similarly, a smart phone could be used incorporating at least some of the functions of connectivity with the object tag or tags, visual imaging of the field of view, at least part of the processing functions, and presentation of the intended display. Other implementations could include a tablet or laptop computer with its camera. Thus, it is observed that many different implementations of the exemplary systems described in the present disclosure can be devised, and the methods and apparatus described are not intended to be limited to the specific examples shown herewithin.

The above described systems thus offer a number of additional advantages over prior art systems. Firstly, they provide a tracking system which is applicable at modest costs even to low cost toys, since the chip is a substantially less costly component than a complete Wi-Fi chipset, for instance, which would enable the toy to connect to other toys through the Internet. Connection to an external server can be implemented from the Console via the Internet, and the server can then provide additional features for the game being played, such as linking a number of players or Consoles, and even connection with remote servers. The playing of video or audio segments on the screen can be achieved either from the server, or from a smart Console. Such systems can be used to render a variety of games interactive and life-like, including such games and toys as card games, animal games (farms or zoos), car play, ball-based games, shooting games, doll games, puppet theatre games, construction kits, digitalization of art work, and many more.

There are a number of different modes in which the various implementations of the tracking systems described in this disclosure can be applied in the field of games. In the first place, the software can simply provide background feedback imagery on the screen, ensuing from the child's or the child's toy's actions, in order to intensify the child's experience of the game which he/she is playing. Thus, for instance, in the example shown in FIG. 1, as a child plays with the toy car, the screen shows an avatar of a car moving in coordination with the movement of the child's car. Thus, if two children are playing, and their cars collide, the processor could generate or draw from the server's library of images, a video clip of such a collision to be shown on the screen. The video clip of a moving or speeding car could even be unrelated to the actual movement of the child's car, but provides visual background to the child's play. In a similar manner, when a child presses a toothbrush into the mouth of a doll, a video clip explaining the importance of the child brushing its teeth properly could be displayed, for instance. All such modes can be termed feedback modes.

A second mode of operation could be in an interactive or challenge mode, in which the child's cognitive abilities are activated to generate actions which are coordinated with the motion of the toys. In this mode, the program may, for instance, ask the child to find a specific object amongst the predetermined toys in front of him/her, and when the correct toy or object is raised by the child, or by the child's doll, the tag within it activates the system provide a video message on the screen relating to the correct action. In this way the child is challenged, and his/her actions are endorsed or commented on, on the screen. Thus, for instance, the child may be told to select a healthy yellow fruit from the plastic models of fruit in the toy shop in front of him/her, and when he/she or his/her doll picks up the toy banana from the model shop, a video clip is shown extolling the virtues of the banana! A third mode of operation is an immersive game mode. In such a mode, the display responds to the physical actions of the child playing, and not just to virtual actions input to the system by means of electromechanical inputs actuated by the child's hands or fingers. Thus, taking the example of a mediaeval battle game, in prior art systems, joysticks, the keyboard, the mouse, or other such elements are used in order to actuate the use of different weapons. Thus, when close combat is necessary, the child will electronically select a sword or a dagger for confronting the enemy electronically on the screen, and when necessary to attack from a distance, a spear or a bow and arrow will be selected to confront the enemy soldier. Using the present system, it is possible for the child to play interactively with real plastic toys. Thus, when the screen shows an approaching enemy formation of soldiers at a distance, the child will pick up his bow and arrow from the toy weapons in front of him, and the RE tag motion sensor within the bow or arrow quiver could actuate the program to show the effect of the child's shooting arrows at the approaching enemy formation. Thus, the system enables the electronic aspects of the game to become integrated with the physical activities of the game itself.

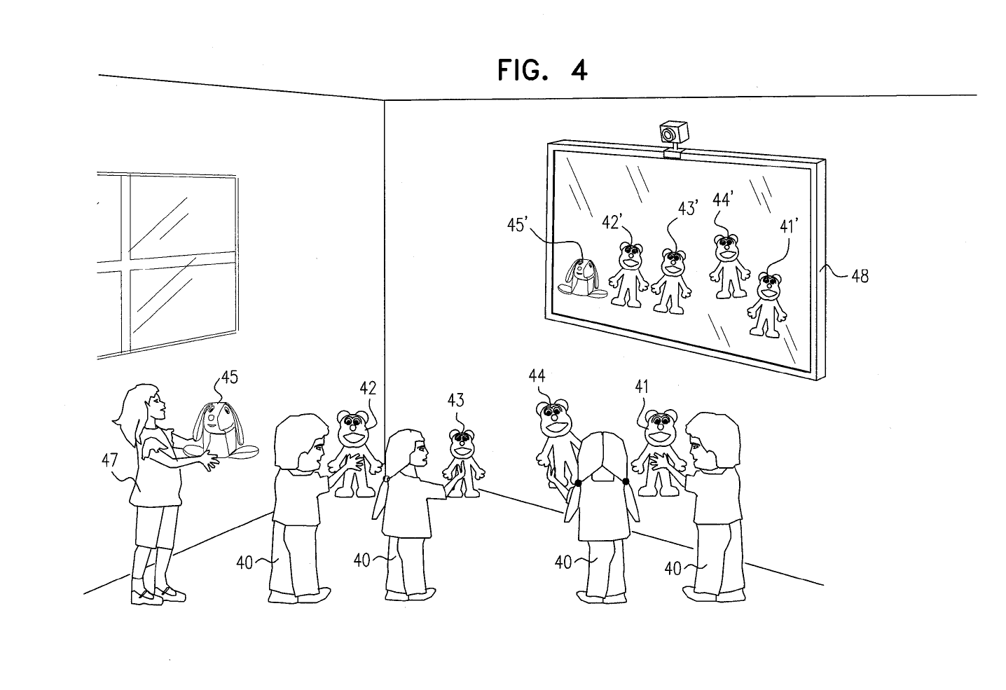

Reference is now made to FIGS. 4 to 6, which illustrate several different examples of such modes of operation of the systems described. In FIG. 4 there is shown an example of the way in which the present disclosure is able to distinguish between identical toys belonging to different children in a group playing together. Thus, in FIG. 4, five children are playing together, four of them 40 with visually identical dolls, 41, 42, 43, 44, while the fifth child 47, has a different doll 45. With prior art systems, no differentiation can be made between the four visually identical dolls. However, in the presently described systems, in which tag and camera corroboration is used, each of the visually identical dolls has a different ID tag which the system is able to identify, and to corroborate with the visual images of the dolls captured by means of the camera system. The images of the dolls can thus be shown on the screen 48, labelled 41′, 42′, 43′ and 44′ for the identical dolls, and 45′ for the different doll. Even though some of the dolls of visually identical, each one is essentially unique and personal, since each doll has its own personal owner, and its own individual play history as stored on the server of the system. This enables children to play together and even to hold competitions between dolls that appear to be identical.

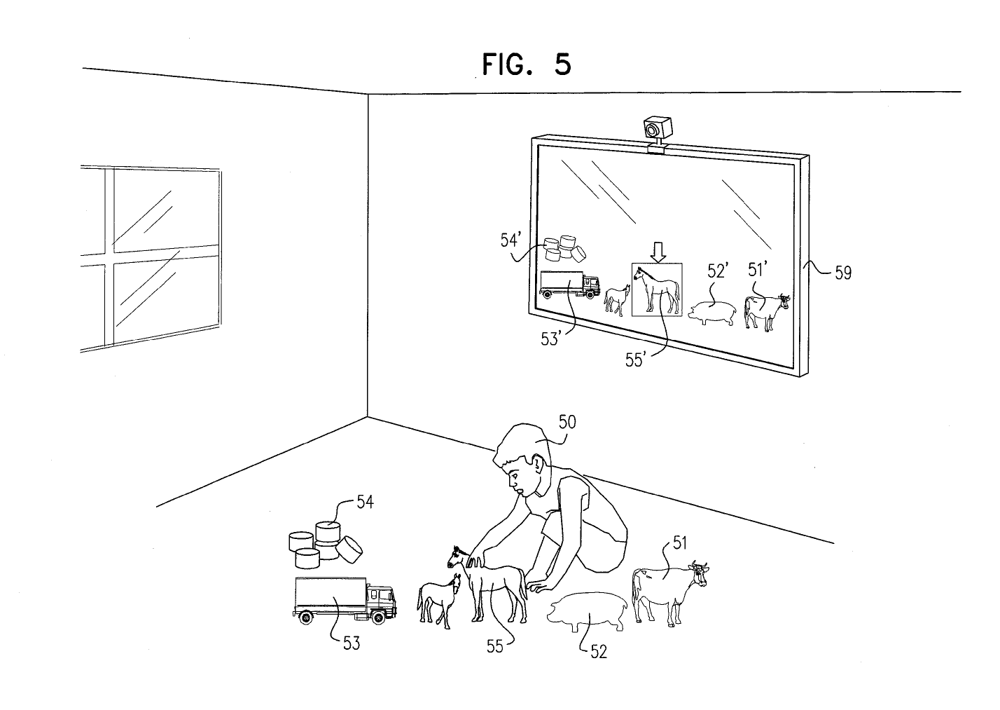

FIG. 5 now shows another scenario which can be connected using the systems of the present disclosure. In this scenario, immediate recognition of an object that is picked up by the child while he/she is playing, can be obtained without any latency. The child 50 is playing with a number of farm animals 51, 52, 53, 54 and 55. These animals are shown on the monitor screen 59, as simulated images of the animals, 51′, 52′, 53′, 54′ and 55′. When he/she goes to pick up the horse 55, the system detects the movement visually and the ID wirelessly. After recognition of the object identity by means of the tag response, the camera can lock immediately onto the chosen animal to follow the actions which the child does with the animal thereafter. Thus, in this scenario, the system is able to recognize any particular one of a multiplicity of objects.

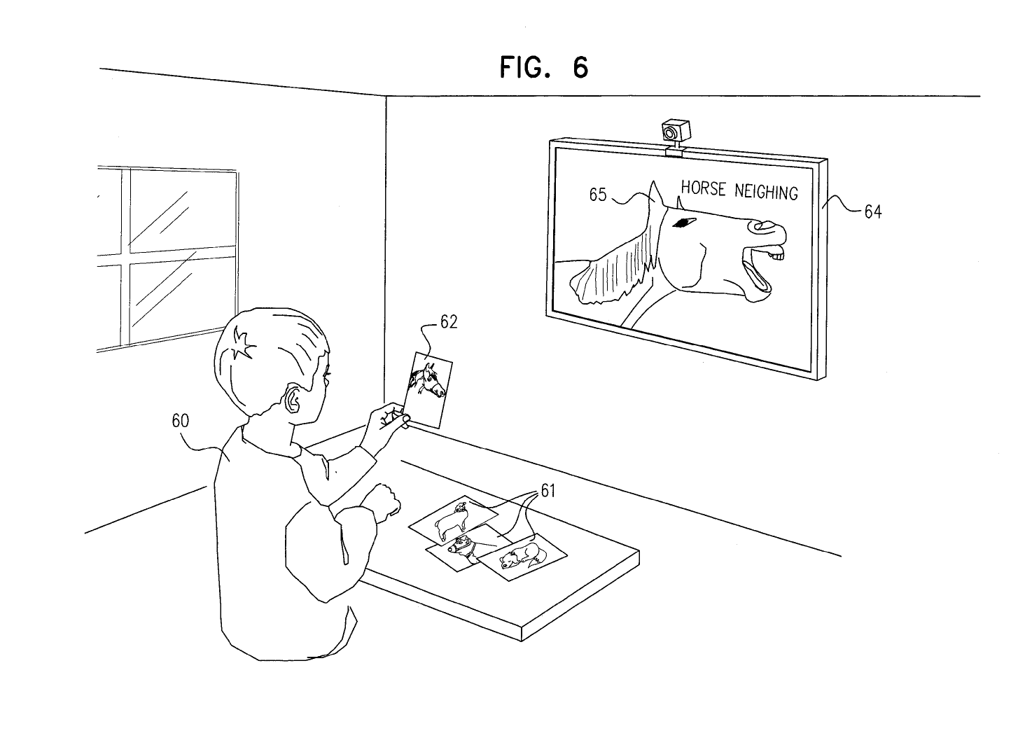

FIG. 6 illustrates yet another scenario, this time involving a card game. The child has selected one card 62 from a group of cards 61 on his/her play table. The selected card 62 is of a horse. Each of the cards has a smart tag printed therewithin, and the action of raising the card 62 from the table sends the ID of the card to the system controller, where the tag movement is corroborated with the captured video image. The resulting output will be of a horse 65 on the screen, and for instance the initiation of a real video of a horse neighing.

In any of these scenarios or in any other games enacted, the history of each of the toys of each child can be saved on the server, either locally or remotely, such that each toy has its own personal history stored ready for use in future games. This personalization of toys is a feature of modern toy marketing procedures, and can be readily performed by the server of the present system.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

1. A system for tracking at least one object in a surveilled area, said system comprising:
an electronic tag and a motion detector associated with said at least one object, said tag being enabled to transmit the identity of said object when said motion detector provides an output indicating motion of said object;
a tag reader adapted to detect any identity transmission from a tag in its vicinity;
an optical detection system for surveilling said area, said system adapted to optically detect motion in said area; and
a control unit adapted to temporally correlate information from the tag reader and from the optical detection system, and to ascribe the identity of a tag detected to an object whose motion is optically detected.

2. A system according to claim 1 wherein said correlation is performed by means of comparison of the time of detection of said information from said tag reader and said optical detection system.

3. A system according to claim 2 wherein said control unit is adapted to instruct said optical detection system to track an object when said motion is optically detected and said identity transmission is received within a predetermined time interval.

4. A system according to claim 3, wherein said controller is adapted to ascribe the identity of said object tracked by said optical detection system according to the identity determined by said tag reader from said identity transmission.

5. A system according to any of the previous claims, wherein the visual features of said at least one object are not discernible to said optical detection system.

6. A system according to any of the claims 1 to 4, wherein said at least one object is a plurality of objects having the same visual appearance, but whose tags provide unique identity information.

7. A system according to any of the previous claims, wherein the ascribed identity of said tag detected by said optically detected motion enables tracking of discrete objects which cannot be distinguished visually by said optical detection system.

8. A system according to any of the previous claims, further comprising a display device, receiving input data from said control unit relating to said at least one object tracked by said system.

9. A system according to claim 8, wherein said input data is such as to show on said display at least one image showing the location of said at least one object tracked by said system.

10. A system according to claim 9, wherein said at least one image showing the location of said at least one object tracked by said system follows the motion of said at least one object in said surveilled area.

11. A system according to claim 8, wherein said input data is such as to show on said display video information relating to said at least one object tracked by said system.

12. A system according to claim 8 wherein at least one of said tag reader, optical detection system, control unit and display are incorporated into a smart electronic device.

13. A system according to claim 12 wherein said smart electronic device is any one of a smart phone, a smart television set or a portable computer.

14. A system according to any of the previous claims, further comprising a server having connectivity with other components of said system, such that information regarding tracking events can be stored on said server and retrieved from said server.

15. A system according to any the previous claims, wherein said motion detector comprises at least one accelerometer, such that said motion detector can transmit electronic information relating to the motion of said at least one object.

16. A system according to claim 15, further comprising a motion analyzing module, such that said electronic information relating to the motion of said at least one object, can be correlated with said information from the optical detection system.

17. A system according to any of the previous claims wherein said tag is either of a Wi-Fi tag or an RFID tag.

18. A method for tracking at least one object in a surveilled area, said method comprising:
providing said at least one object with an electronic tag and a motion detector, said tag transmitting the identity of said object when said motion detector provides an output indicating motion of said object;
detecting any identity transmission received from a tag in said area;
optically detecting motion in said area with an optical detection system; and
temporally correlating the tag associated with any identity transmission received, with optically detected motion; and
ascribing an object associated with said optically detected motion with the identity of said tag whose identity transmission was detected.

19. A method according to claim 18 wherein said correlating is performed by comparing the time of detection of said identity transmission with the time of said optically detecting said motion.

20. A method according to claim 19 wherein said tracking at least one object is performed when said optically detected motion and said identity transmission are received within a predetermined time interval.

21. A method according to any of claims 18 to 20, wherein the visual features of said at least one object are not discernible to said optical detection system.

22. A method according to any of the claims 18 to 20, wherein said at least one object is a plurality of objects having the same visual appearance, but whose tags provide unique identity information.

23. A method according to any of claims 18 to 22, wherein said ascribed identity of said tag detected to said optically detected motion enables tracking of discrete objects which cannot be distinguished visually by said optical detection system.

24. A method according to any of claims 18 to 23, further comprising the step of presenting on a display information relating to said at least one object tracked.

25. A method according to claim 24, wherein said information comprises location information about said at least one object.

26. A method according to claim 25, wherein said location information about said at least one object tracks the motion of said at least one object in said surveilled area.

27. A method according to claim 24, wherein said information comprises video information relating to said at least one object tracked by said system.

28. A method according to claim 24 wherein at least one of said steps of detecting an identity transmission, optically detecting motion, temporally correlating, ascribing and presenting on a display, is performed on a smart electronic device.

29. A method according to claim 28 wherein said smart electronic device is any one of a smart phone, a smart television set or a portable computer.

30. A method according to any of claims 18 to 29, further comprising the step of connecting with a server, such that information regarding tracking events can be stored on said server and retrieved from said server.

31. A method according to any of claims 18 to 30, wherein said motion detector comprises at least one accelerometer, such that said motion detector can transmit electronic information relating to the motion of said at least one object.

32. A method according to claim 31, further comprising the step of correlating said electronic information relating to the motion of said at least one object, with said optically detected motion.

33. A method according to any of claims 18 to 32, wherein said electronic tag is either of a Wi-Fi tag or an RFID tag.

34. A system for tracking at least one object in a surveilled area, said system comprising:
an electronic tag and a light sensor associated with said at least one object, said light sensor being adapted to provide an output signal when a change in the level of light caused by motion of said object is detected, and said tag being enabled to transmit the identity of said object only when said light sensor provides such an output signal;
a tag reader adapted to detect any identity transmission from a tag in its vicinity;
an optical motion sensor system for surveilling said area, said system adapted to optically detect and characterize any motion in said area; and
a control unit operative to correlate the information from the tag reader and the optical motion sensor and to ascribe the identity of said tag detected to said optically detected motion.
